(19) United States
(12) Patent Application Publication
(10) Pub. No.: US 2012/0031994 A1
(43) Pub. Date: Feb. 9, 2012

(54) METHOD AND EQUIPMENT FOR SURFACE TREATMENT BY CRYOGENIC FLUID JETS

(75) Inventors: Charles Truchot, Poussy (FR); Jacques Quintard, Presles (FR); Frédéric Richard, Parmain (FR)

(73) Assignee: L'Air Liquide Societe Anonyme pour I'Etude et I'Et ude et I'Exploitation des Procedes George Claude, Paris (FR)

(21) Appl. No.: 13/264,077

(22) PCT Filed: Mar. 16, 2010
(86) PCT No.: PCT/FR10/50464

§ 371 Date: Oct. 12, 2011

(30) Foreign Application Priority Data
Apr. 15, 2009 (FR) 0952464

(51) Int. Cl. A62C 5/02; B05B 1/26

(52) U.S. Cl. 239/8; 239/543

(57) ABSTRACT

The invention relates to working equipment, particularly for heat treatment, pickling, or the like, implementing high pressure liquid jets at cryogenic temperatures including a rotary or swinging tool (4) comprising one or more nozzles (11) for dispensing high pressure liquid jets at cryogenic temperatures, and a motor (21) for rotating or swinging the tool (4). The motor (21) is connected to the tool (4) via a rotary transmission shaft (22) and a transmission gearbox (23) containing an internal transmission mechanism, typically with sprockets (24) or belts. The equipment further comprises means (28) for feeding dry gas, such as nitrogen or dry air, in communication with the inside of the transmission gearbox (23) designed for and capable of feeding the inside or said transmission gearbox (23) with dry gas. Said injection of gas into the transmission gearbox (23) prevents the contamination of the inside of the transmission gearbox with atmospheric impurities.

### CROSS REFERENCE TO RELATED APPLICATIONS

This application is a 371 of International PCT Application PCT/FR2010/050464, filed Mar. 16, 2010, which claims priority to French Application 0952464, filed Apr. 15, 2009, the entire contents of which are incorporated herein by reference.

### DESCRIPTION

The invention relates to an item of equipment and to a method for working using jets of cryogenic fluid under high pressure, particularly for surface-treating, pickling or scalping coated or non-coated materials such as metals, concrete, wood, polymers and plastics or any other type of material.

At the present time, the surface-treatment of coated or non-coated materials, particularly the pickling, scalping or the like thereof, is essentially performed using sandblasting, by ultra-high-pressure (UHP) water jetting, using scourers, pneumatic picks, scabblers or alternatively via a chemical route.

However, when there must not be any water involved, for example in a nuclear environment, or chemical product, for example because of severe environmental constraints, only so-called “dry” working methods can be used.

However, in some instances, these “dry” methods are difficult to employ, are very laborious or awkward to use or else generate additional pollution, for example because of the addition of shot or of sand that has subsequently to be reprocessed.

One alternative to these technologies relies on the use of cryogenic jets under very high pressure, as proposed in documents U.S. Pat. No. 7,310,955 and U.S. Pat. No. 7,316,363. In such cases, use is made of one or more jets of liquid nitrogen at a pressure of 1000 to 4000 bar and at a cryogenic temperature comprised for example between −100 and −200° C., typically between approximately −140 and −160°, which are distributed by a nozzle-bearing tool which is set in motion, typically a rotational or oscillatory movement, obtained through a system involving gearwheels or belts driven by a motor.

However, the transmission box that usually contains the set of gearwheels is never perfectly fluidtight and in any case cannot be made completely fluidtight because of the presence of moving parts that cross through its wall, and because of the expansion of the parts and the variations in pressure caused by the significant variations in temperatures that occur during use of the equipment.

Now, the lack of fluidtightness of the box and therefore the inevitable presence of gaps through its wall causes major problems, namely:
because of the very low temperatures employed, the water vapor that the air inside the transmission box inevitably contains crystallizes into ice and builds up with increasing use of the equipment, and this tends to prevent the gearwheels from rotating correctly and therefore to impede the rotary or oscillatory movement of the nozzle-bearing tool. As a result then, the equipment has to be shut down so that the transmission box can be warmed up thus melting the ice crystals.
certain applications may generate a great deal of dust which also has a tendency to infiltrate into and build up in the transmission box and the gearwheels or meshing pairs, and this too tends to prevent the gearwheels from rotating and therefore to prevent the nozzle-bearing tool from moving. As before, this build-up of dust leads to compulsory shut-downs so that the box can be cleaned out.

The shut-downs may be curative, that is to say carried out when a problem arises, or preventive, that is to say carried out before the problem arises, when, for example, it is known from experience that, after a given time, it is best to carry out a maintenance shutdown in order to avoid any problem.

In both instances the result is nonetheless significant losses of output and of productivity and risk of gearwheel damage or even damage to other parts of the equipment if the maintenance is not carried out in time, and also a negative impact on the effectiveness of the heat treatment, for example pickling or the like, that is to be performed.

The problem addressed is therefore that of avoiding or minimizing these contaminations by ambient impurities, such as water vapor or dust, of the non-fluidtight transmission box containing gearwheels or some other internal mechanism of an item of working equipment using cryogenic jets under very high pressure, particularly an item of surface-treatment, pickling or scalping equipment or the like.

The solution therefore relates to an item of working equipment employing at least one jet of fluid at cryogenic temperature and under high pressure, comprising:
a source of fluid at a cryogenic temperature and fluidically connected to a moving tool,
the moving tool comprising one or more fluid distribution nozzles for distributing one or more jets of said fluid at cryogenic temperature and under high pressure, and
a motor for driving the moving tool in rotation,
the motor being connected to the moving tool by a transmission shaft and a transmission box with a transmission mechanism,
said transmission shaft entering the transmission box and interacting with the transmission mechanism arranged in said transmission box in such a way as to transmit the rotational movement of the motor to the moving tool.

The equipment of the invention is characterized in that it further comprises dry gas supply means in fluidic communication with the inside of the transmission box and designed and able to supply the inside of said transmission box with a dry gas.

Depending on circumstance, the equipment of the invention may comprise one or more of the following features:
the moving tool can move in terms of rotation or in terms of oscillation,
the transmission mechanism comprises one or more gearwheels or belts,
the dry gas supply means comprise a source of dry gas in fluidic communication with the inside of the transmission box,
the dry gas supply means comprise a source of dry nitrogen or of dry air,
it comprises at least one heat exchanger comprising an exhaust device, particularly a vent, arranged between the source of fluid at cryogenic temperature and the rotary tool, the dry gas supply means being fluidically connected to said exhaust device in such a way as to be able to recuperate at least some of the gas escaping via said exhaust device,
the source of fluid at cryogenic temperature is a tank containing a cryogenic liquid under a gas blanket, the dry gas supply means being fluidically connected to said gas blanket of the source of fluid at cryogenic temperature.

The invention also relates to a method for avoiding or minimizing the contamination with atmospheric impurities of the inside of a transmission box of an item of working equipment, particularly one according to the invention, characterized in that a dry gas is introduced into the transmission box, said dry gas containing less than 20 vol % of water vapor and being at a pressure greater than or equal to atmospheric pressure.

Depending on circumstance, the method of the invention may comprise one or more of the following features:
the dry gas is at a pressure higher than atmospheric pressure, preferably at a pressure greater than 1 bar and less than or equal to 400 bar,
the dry gas is air or nitrogen, preferably nitrogen from some other stage in the method or nitrogen that is a waste gas from the equipment,
the dry gas is nitrogen from the exhaust device of a heat exchanger of the equipment and/or from the gas blanket of the source of cryogenic fluid,
the cryogenic fluid distributed by the nozzle or nozzles of the tool is at a pressure of at least 1000 bar, preferably between 2000 and 5000 bar, and at a temperature below −140° C., preferably between around −140 and −180° C.
the atmospheric impurities are water vapor and the solid particles carried by the air, particularly dust, and the residues generated,
the flow rate of the dry gas supplied to the inside of the transmission box is comprised between 0.1 and 100 l/min, preferably between 1 and 10 l/min.

Moreover, the invention also relates to a method of surface-treating, pickling or scalping a material using cryogenic fluid at high pressure, in which use is made of an item of equipment according to the invention, or of a method for avoiding or minimizing the contamination with atmospheric impurities of the inside of a transmission box of an item of equipment according to the invention.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 is a schematic depiction of the operation of an item of working equipment employing cryogenic jets under very high pressure,

FIGS. 2a (which is a side view) and 2b (which is a view from underneath) schematically depict the nozzle-bearing tool with which the equipment of FIG. 1 is equipped,

FIG. 3 schematically depicts the drive mechanism that drives the nozzle-bearing tool with which the equipment of FIG. 1 is equipped, and

FIG. 4 schematically depicts an embodiment according to the present invention for preventing the ingress of water vapor or atmospheric dust into the housing of the mechanism of FIG. 3.

As can be seen in FIG. 1, an item of equipment for pickling, surface treatment or the like using jets of cryogenic liquid conventionally comprises a storage reservoir 1, such as a tank, of liquid nitrogen (hereinafter termed LN₂) which, via a liquid nitrogen supply line 6 at low pressure, that is to say a pressure of about 3 to 6 bar and at a temperature of the order of −180° C., supplies a compression device 2, having a compressor and internal upstream heat exchanger that places the liquid nitrogen under ultra-high-pressure (UHF).

The compression device 2 is therefore able to compress the LN₂ that comes from the storage reservoir 1.

The LN₂ at the first pressure (UHP) is then carried via a carrying line (7) as far as an external downstream heat exchanger 3 where the UHP LN₂ is cooled with liquid nitrogen at atmospheric pressure (at 9) typically to obtain UHP liquid nitrogen.

This results in LN₂ at a pressure (UHF) typically higher than 1000 bar, generally comprised between 2000 bar and 5000 bar, and advantageously comprised between around 3000 and 4000 bar, and at a temperature of below −140° C., typically between −140° C. and −180° C., for example of the order of around −150 to −160° C., which is sent (at 8) to the pickling or the like tool 4 that delivers one or more jets of UHP liquid nitrogen, generally several jets.

The high-capacity reservoir 1, such as a truck tank or a storage reservoir capable of storing several thousand liters of liquid nitrogen, is generally situated outside the buildings, that is to say in the open air. It may be fixed or mobile.

The high-capacity reservoir 1 is connected in the conventional way to the equipment, that is to say by means of insulated piping comprising one or more control valves, etc. Further, the carriage of the LN₂ between the various elements of the system is also via insulated piping. The overall gas flow rate is approximately 20 l/min, i.e. 15 m³/min.

In general, the compression device 2, the external exchanger 3 and especially the tool 4 are, in theory, situated inside one or more building(s).

During operation of the heat treatment or the like method, gaseous nitrogen at atmospheric pressure (about 1 bar) and at around −196° C. is continuously escaping from the two exchangers, namely from the upstream exchanger of the compression device 2 and from the downstream exchanger 3.

This escape of gaseous nitrogen is via an exhaust device, such as a vent or the like, arranged on each of said heat exchangers 2, 3.

In equipment of the prior art, this released nitrogen is not reused but is generally collected and removed from the buildings in order to eliminate the risk of asphyxiation of the personnel, that is to say it constitutes a waste gas which is discharged into the atmosphere.

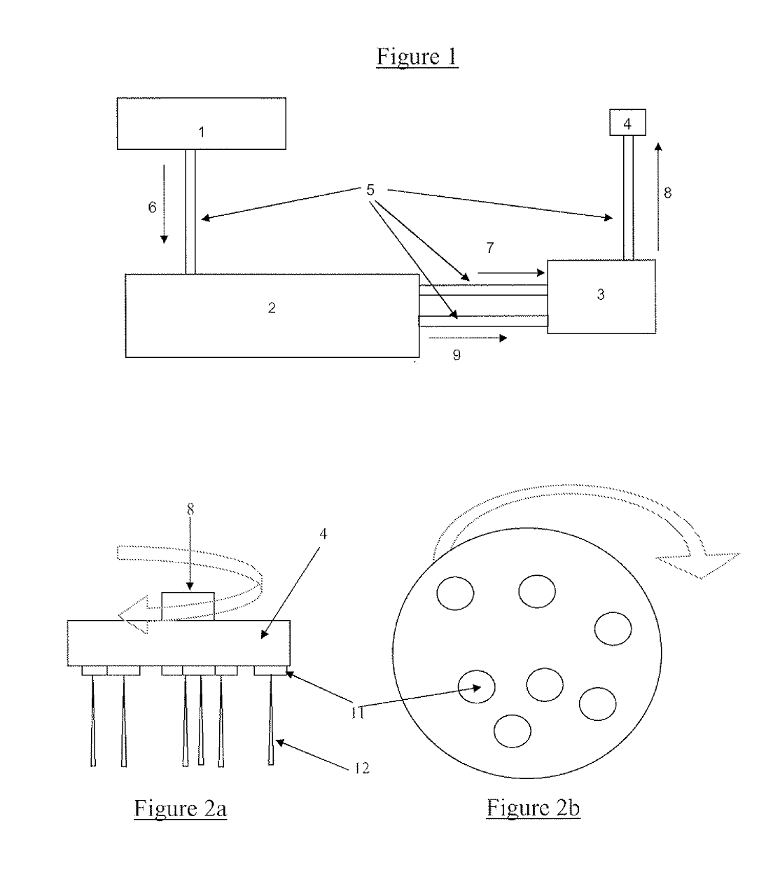

What is more, in order to increase the size of the surface treated, that is to say pickled or the like, use is typically made of a tool 4 equipped with nozzles 11 of the kind used in UHP water jet methods, but here supplied with UHP LN₂ (at 8) and that are rotated or oscillated in such a way as to obtain rotary jets 12 of UHP LN₂ which are used to pickle (or equivalent) the surface that is to be treated, as illustrated in FIG. 2a (a side view) and FIG. 2b (a view from beneath).

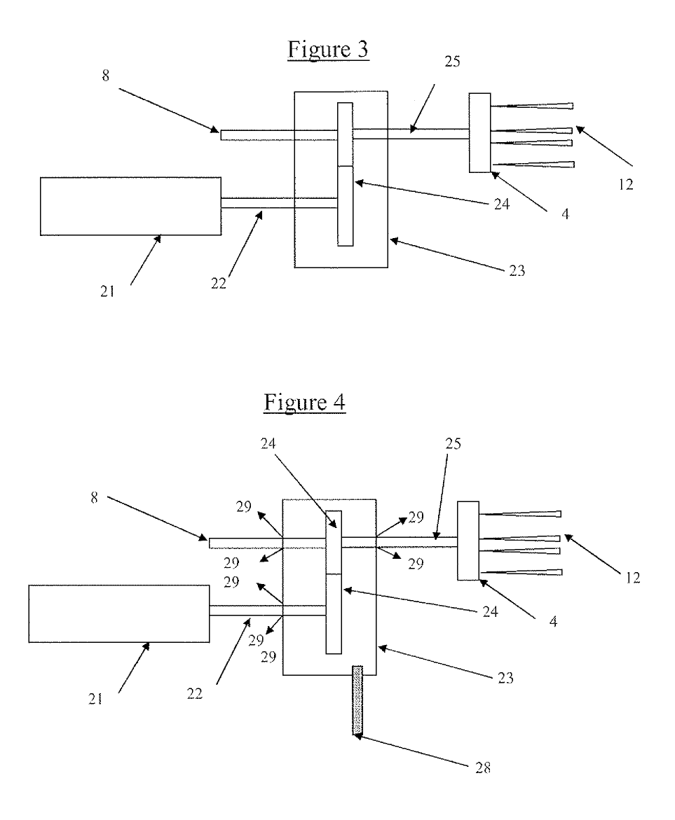

As can be seen from the diagram that is FIG. 3, the nozzle-bearing tool 4 here is set in rotation by a set of gearwheels 24, with or without transmission belt, driven by an electric or pneumatic motor 21 via a first rotary transmission shaft or spindle 22 connected to the motor 21, of a transmission box, housing or chamber 23 containing a transmission mechanism with an internal set of gearwheels 24 and a second transmission shaft or spindle 25, here a rotary shaft or spindle, which for its part is connected to the moving tool 4 that is fitted with the nozzles.

However, the transmission box 23 containing the transmission mechanism with a set of gearwheels 24 or the like is never perfectly fluidtight. This is because it would be difficult if not to say near impossible to have a box 23 that was fluidtight notably because of the expansion of the parts and because of the variations in pressure caused by the significant variations in temperature when the equipment is being used, namely the transition from ambient temperature to cryogenic temperatures, which creates gaps.

Now, this lack of fluidtightness of the transmission box 23 containing the transmission mechanism with a set of gearwheels 24 presents problems in equipment of the prior art because it allows the ingress of atmospheric impurities, particularly water vapor and various forms of dust into said transmission box 23 via said gaps.

These impurities then have a tendency to build up in the box over time and give rise to problems of fouling of the transmission mechanism, particularly the gearwheels.

Hence, as already explained hereinabove, because of the very low temperatures involved, the water vapor inevitably contained in the ambient air present in the transmission box 23 crystallizes into ice and builds up over time with use of the equipment. Now, these deposits of ice crystals tend gradually to prevent the gearwheels 24 from rotating (or oscillating) correctly and therefore tend to prevent the moving nozzle-bearing tool 4 from moving. This then results in compulsory shut-downs of the equipment, at a given frequency, so that the transmission box 23 can be heated up and the ice crystals therefore melted.

Similarly, certain applications may generate a great deal of dust which has a tendency to enter and build up in the transmission box 23 and likewise prevent the gearwheels 24 of the transmission mechanism from rotating and therefore prevent the nozzle-bearing tool from moving. Once again, these build-ups of dust give rise to compulsory shut-downs so that the box 23 can be cleaned out and rid of the accumulated dust.

The solution according to the present invention therefore relies on the idea of introducing dry and clean gas, at a slight raised pressure, into the transmission box as depicted schematically in FIG. 4 and detailed hereinafter.

FIG. 4 is similar to FIG. 3 except that, according to the invention, the transmission box 23 is supplied with dry and clean gas at a raised pressure in relation to atmospheric pressure via dry gas supply means 28 which are in fluidic communication with the inside of the transmission box 23.

The supply means 28 comprise a dry gas supply line fluidically connected to a source of dry gas, preferably dry and clean gaseous nitrogen or dry and clean air, that is to say gas containing no water vapor, no dust and no other atmospheric aerosol impurities liable to crystallize, become deposited on or build up in the transmission box 23, in particular in the transmission mechanism.

The dry and clean gas, whatever its nature might be, may come from a cylinder, a container, a gas reservoir, a dedicated compressor fitted with filters or any other gas purification means, a gas supply line or a piping network.

However, use is advantageously made of the gas from the gas blanket of the tank or reservoir 1, but more preferably, use is made of the waste gas, namely the gaseous nitrogen, discharged via the vents from the upstream exchanger 2 or the downstream exchanger 3 of the equipment of FIG. 1.

The dry and clean gas is introduced into the transmission box 23 at a raised pressure in relation to atmospheric pressure, i.e. at a pressure greater than 1 bar (1 atm).

As illustrated in FIG. 4, the pressurized gas introduced into the transmission box 23 then occupies the interior volume of the transmission box 23 and some of the gas escapes (arrows 29) because of its raised pressure via the gaps inevitably present in the wall of the transmission box 23 as a result of the fact that it is impossible to achieve a transmission box 23 that is completely fluidtight.

In particular, it may be seen that these gaps or other leakage orifices are located, in this instance, at the points where:
the rotary transmission shaft or spindle 22 and the UHP cryogenic fluid supply line 8 enter the transmission box 23 containing the gearwheels 24, and
the rotary transmission shaft or spindle 25 driving the tool 4 leaves said transmission box 23.

This is because at these points the wall of the transmission box 23 has orifices for the passage of the aforementioned shafts and lines and which cannot be completely fluidtight even if seals or other sealing means are used, given that all or some of these mechanical components are moving parts, particularly the rotary spindles 22, 25. This is also true when the tool 4 is driven with an oscillatory movement.

By creating a raised pressure inside the transmission box 23 according to the present invention, atmospheric impurities, which are at ambient atmospheric pressure, are prevented from being able to enter the transmission box 23 because of the difference in pressure created between the inside and the outside of the box or housing 23.

The dry gas used for that contains less than 20 vol % of water vapor and is therefore at a pressure higher than the ambient atmospheric pressure obtaining outside the box or chamber 23. For preference, the dry gas used has a zero or near-zero water content and contains no dust.

In the context of the invention, the chief aim is in fact to avoid the ingress of dust and water vapor. However, thanks to the invention, it is possible to prevent or at least considerably slow down the ingress of all gaseous or aerosol compounds liable to present a problem if they build up inside the box 23, for example CO₂ which could solidify into dry ice inside the box 23 and present the same problems as the water vapor which crystallizes into ice therein. The invention therefore also relates to these other potentially harmful impurities.

If necessary, the dry gas can be purified before it is injected into the box 23, for example can be filtered or treated by an adsorption system, for example by passing it over particles of adsorbent of the alumina, zeolite, silica gel or similar type.

The present invention applies to any operation involving heat treatment by jets of cryogenic fluid, particularly operations of surface-treating, pickling or scalping a material such as metals, concrete, stone, plastics, wood, etc.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1-13. (canceled)

14. An item of working equipment employing at least one jet of fluid at cryogenic temperature and under high pressure, comprising:
a source (1) of fluid at cryogenic temperature and fluidically connected to a moving tool (4),
the moving tool (4) comprising one or more fluid distribution nozzles (11) for distributing one or more jets of said fluid at cryogenic temperature and under high pressure, and
a motor (21) for driving the moving tool (4),
the motor (21) being connected to the tool (4) by a rotary transmission shaft (22) and a transmission box (23) comprising a transmission mechanism (24),
said transmission shaft (22) entering the transmission box (23) and interacting with the transmission mechanism (24) arranged in said transmission box (23) in such a way as to be capable of transmitting the rotational movement of the motor (21) to the moving tool (4),
a dry gas supply (28) in fluidic communication with the inside of the transmission box (23) and adapted to supply the inside of said transmission box (23) with a dry gas.

15. The item of working equipment of claim 14, wherein the dry gas supply (28) comprises a source of dry nitrogen or of dry air.

16. The item of working equipment of claim 14, wherein the tool (4) is capable of movement in terms of rotation or in terms of oscillation and/or the transmission mechanism (24) comprises one or more gearwheels or belts.

17. The item of equipment of claim 14, wherein the item of working equipment comprises at least one heat exchanger (2; 3), the heat exchanger comprising an exhaust device, arranged between the source (1) of fluid at cryogenic temperature and the rotary tool (4), the dry gas supply being fluidically connected to said exhaust device in such a way as to be able to recuperate at least some of the gas escaping via said exhaust device.

18. The item of equipment of claim 14, wherein the source (1) of fluid at cryogenic temperature is a tank containing a cryogenic liquid under a gas blanket, the dry gas supply being fluidically connected to said gas blanket of the source (1) of fluid at cryogenic temperature.

19. A method for avoiding or minimizing contamination with atmospheric impurities of the inside of a transmission box (23) of the item of working equipment of claim 14, comprising the step of introducing dry gas is into the transmission box (23), said dry gas containing less than 20 vol % of water vapor and being at a pressure greater than or equal to atmospheric pressure.

20. The method of claim 19, wherein the dry gas is at a pressure greater than 1 bar and less than or equal to 400 bar.

21. The method of claim 19, wherein the dry gas is air or nitrogen.

22. The method of claim 19, wherein the dry gas is nitrogen from an exhaust device of a heat exchanger of the item of working equipment and/or from the gas blanket of the source (1) of cryogenic fluid.

23. The method of claim 19, wherein the source (1) is a cryogenic fluid, the cryogenic fluid is delivered by a nozzle of the tool (4) at a pressure of at least 1000 bar and at a temperature below −140° C.

24. The method of claim 19, wherein the atmospheric impurities are water vapor and the solid particles carried by the air, particularly dust.

25. The method of claim 19, wherein a flow rate of the dry gas introduced into the inside of the transmission box (23) is between 0.1 and 100 l/min.
